(19) United States
(12) Patent Application Publication
(10) Pub. No.: US 2026/0011074 A1
(43) Pub. Date: Jan. 8, 2026

(54) SYSTEMS AND METHODS FOR DIFFUSION-BASED FACIAL PERFORMANCE RELIGHTING

(71) Applicant: Netflix, Inc., Los Gatos, CA (US)

(72) Inventors: Mingming He, Los Gatos, CA (US); Pascal Clausen, Los Gatos, CA (US); Ahmet Tasel, Los Gatos, CA (US); Li Ma, Los Gatos, CA (US); Oliver Pilarski, Los Gatos, CA (US); Wenqi Xian, Los Gatos, CA (US); Laszlo Rikker, Los Gatos, CA (US); Xueming Yu, Los Gatos, CA (US); Ryan Burgert, Los Gatos, CA (US); Ning Yu, Los Gatos, CA (US); Paul E. Debevec, Los Gatos, CA (US)

(21) Appl. No.: 19/258,321

(22) Filed: Jul. 2, 2025

Related U.S. Application Data
(60) Provisional application No. 63/667,470, filed on Jul. 3, 2024.

(51) Int. Cl. G06T 15/50; G06T 5/60; G06T 5/70; G06T 15/20

(52) U.S. Cl. CPC G06T 15/506; G06T 5/60; G06T 5/70; G06T 15/205; G06T 2207/20081; G06T 2207/20084; G06T 2207/20208

(57) ABSTRACT

The disclosed computer-implemented method may include receiving, by a computing device, multi-view flat-lit performance data of a subject. Additionally, the method may include rendering, by the computing device, a dynamic sequence of novel-view flat-lit images of the subject based on a deformable three-dimensional Gaussian splatting (3DGS) model. The method may also include providing the rendered dynamic sequence of flat-lit images as input to a diffusion-based relighting model trained on the multi-view flat-lit performance data of the subject. Furthermore, the method may include generating, by the computing device using the diffusion-based relighting model, a relit sequence of the subject under a specified lighting condition. Various other methods, systems, and computer-readable media are also disclosed.

### CROSS REFERENCE TO RELATED APPLICATION

This application claims the benefit of U.S. Provisional Application No. 63/667,470, filed 3 Jul. 2024, the disclosure of which is incorporated, in its entirety, by this reference.

### BACKGROUND

For digital media applications, digital representations of human faces are becoming increasingly prominent in contexts such as film, video games, and virtual reality. For example, digital human models can be constructed to generate facial images as needed, but it can be difficult and expensive to construct realistic models, particularly for videos. In many instances, capturing the full nuance of facial appearance, including subtle shading, highlights, and textural details, is important for integration into diverse digital environments. Traditionally, facial performances have been recorded under a single, uniform lighting condition, which limits the flexibility required to generate varied, high-quality renderings. For example, volumetric performance capture (volcap) systems use arrays of inward-pointing cameras to record dynamic human performances. However, volcap is generally captured under flat lighting, which limits lighting effects and integration of human models into new environments. Additionally, for videos, errors created by distortions can accumulate over time, creating larger distortions for longer video sequences that can appear as video flicker or weave.

Various techniques have been developed to address these challenges, including parametric reflectance modeling, image-based relighting, and intrinsic image relighting that simulate different lighting conditions. Although these approaches provide potential solutions, they often encounter obstacles such as high processing costs, limited control over complex light interactions, and inconsistencies when applied across dynamic sequences. For instance, methods that rely on image decomposition or simplified reflectance models may struggle to faithfully reproduce effects like self-shadowing, subsurface scattering, and fine-scale highlights. Traditional methods often train large-scale data that can be generalized but is less accurate or use diversion-based modeling for portrait lighting. Other methods may require capturing photometric normals in multi-view dynamic settings, which can be difficult due to hardware constraints. Thus, better methods of facial performance relighting are needed to provide robust, scalable techniques that provide precise lighting control while maintaining the fidelity of facial details for different viewpoints and expressions.

### SUMMARY

As will be described in greater detail below, the present disclosure describes systems and methods for diffusion-based facial performance relighting. In one example, a computer-implemented method for diffusion-based facial performance relighting may include receiving, by a computing device, multi-view flat-lit performance data of a subject. The method may also include rendering, by the computing device, a dynamic sequence of novel-view flat-lit images of the subject based on a deformable three-dimensional Gaussian splatting (3DGS) model. In addition, the method may include providing the rendered dynamic sequence of flat-lit images as input to a diffusion-based relighting model trained on the multi-view flat-lit performance data of the subject. Furthermore, the method may include generating, by the computing device using the diffusion-based relighting model, a relit sequence of the subject under a specified lighting condition.

In one embodiment, the multi-view flat-lit performance data includes pairs of images for the subject, wherein each pair of images includes a flat-lit image and a one-light-at-a-time (OLAT) image that is identical to the flat-lit image except for lighting. In this embodiment, the pairs of images include images with a range of subject positions, angles, and lighting conditions. In this embodiment, the pairs of images are captured by a light emitting diode (LED) panel stage.

In one example, the deformable 3DGS model is trained by partitioning a training sequence in the multi-view flat-lit performance data into segments, training the deformable 3DGS model on a sample of keyframes as an initialization, and training the deformable 3DGS model for each segment conditioned on the initialization. In this example, each segment contains a beginning keyframe and an end keyframe from the sample of keyframes, wherein training the deformable 3DGS model for each segment is based on a timestamp of the beginning keyframe.

In some embodiments, rendering the dynamic sequence of flat-lit images includes reconstructing deformed Gaussians based on the deformable 3DGS model.

In some examples, the diffusion-based relighting model generates the relit sequence by encoding the dynamic sequence of flat-lit images into latent space, concatenating the encoded dynamic sequence of flat-lit images with random noise for input to a convolutional neural network, conditioning the input to the convolutional neural network with text embedding containing lighting information, and decoding a result of the convolutional neural network as the relit sequence. In these examples, the lighting information is encoded using spherical harmonics, wherein spherical Gaussians determine lighting direction and lighting size. In these examples, the convolutional neural network is trained to predict noise for the latent space of the dynamic sequence of flat-lit images such that the diffusion-based relighting model iteratively removes the noise from the random noise to generate a clean image latent, wherein the convolutional neural network is trained using pyramid noise.

In one example, the specified lighting condition includes one or more of a lighting direction and/or an area lighting parameter.

In one embodiment, generating the relit sequence includes adjusting the specified lighting condition to reconstruct a high dynamic range map by compositing a set of OLAT inferences using spherical Gaussians.

In some examples, the computer-implemented method may further include applying temporal blending to the relit sequence by interpolating relit results between keyframes.

In addition, a corresponding system for diffusion-based facial performance relighting may include several modules stored in memory, including a reception module that receives, by a computing device, multi-view flat-lit performance data of a subject. The system may also include a rendering module that renders, by the computing device, a dynamic sequence of novel-view flat-lit images of the subject based on a deformable three-dimensional Gaussian splatting (3DGS) model. In addition, the system may include an input module that provides the rendered dynamic sequence of flat-lit images as input to a diffusion-based relighting model trained on the multi-view flat-lit performance data of the subject. Furthermore, the system may include a generation module that generates, by the computing device using the diffusion-based relighting model, a relit sequence of the subject under a specified lighting condition. Finally, the system may include one or more processors that execute the reception module, the rendering module, the input module, and the generation module.

In one embodiment, the multi-view flat-lit performance data includes pairs of images for the subject, wherein each pair of images includes a flat-lit image and a one-light-at-a-time (OLAT) image that is identical to the flat-lit image except for lighting.

In one example, the deformable 3DGS model is trained by partitioning a training sequence in the multi-view flat-lit performance data into segments, training the deformable 3DGS model on a sample of keyframes as an initialization, and training the deformable 3DGS model for each segment conditioned on the initialization.

In some embodiment, the generation module uses the diffusion-based relighting model to generate the relit sequence by encoding the dynamic sequence of flat-lit images into latent space, concatenating the encoded dynamic sequence of flat-lit images with random noise for input to a convolutional neural network, conditioning the input to the convolutional neural network with text embedding containing lighting information, and decoding a result of the convolutional neural network as the relit sequence.

In some examples, the convolutional neural network is trained to predict noise for the latent space of the dynamic sequence of flat-lit images such that the diffusion-based relighting model iteratively removes the noise from the random noise to generate a clean image latent, wherein the convolutional neural network is trained using pyramid noise.

In one embodiment, the generation module generates the relit sequence by adjusting the specified lighting condition to reconstruct a high dynamic range map by compositing a set of OLAT inferences using spherical Gaussians.

In some examples, the above-described method may be encoded as computer-readable instructions on a non-transitory computer-readable medium. For example, a computer-readable medium may include one or more computer-executable instructions that, when executed by at least one processor of a computing device, such as a server, may cause the computing device to receive multi-view flat-lit performance data of a subject. The instructions may also cause the computing device to render a dynamic sequence of novel-view flat-lit images of the subject based on a deformable three-dimensional Gaussian splatting (3DGS) model. In addition, the instructions may cause the computing device to provide the rendered dynamic sequence of flat-lit images as input to a diffusion-based relighting model trained on the multi-view flat-lit performance data of the subject. Furthermore, the instructions may cause the computing device to generate, using the diffusion-based relighting model, a relit sequence of the subject under a specified lighting condition.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for diffusion-based facial performance relighting.

FIG. 2 is a block diagram of an exemplary computing system for diffusion-based facial performance relighting.

FIG. 3 is a block diagram of an exemplary image capture process.

FIG. 4 is a block diagram of an exemplary deformable 3DGS model.

FIG. 5 is a block diagram of an exemplary diffusion-based relighting model.

FIG. 6 is a block diagram of an exemplary environmental relighting.

FIG. 7 is a block diagram of an exemplary content distribution ecosystem.

FIG. 8 is a block diagram of an exemplary distribution infrastructure within the content distribution ecosystem shown in FIG. 7.

FIG. 9 is a block diagram of an exemplary content player within the content distribution ecosystem shown in FIG. 7.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to diffusion-based facial performance relighting. As will be explained in greater detail below, embodiments of the present disclosure may, by focusing on subject-specific datasets and using advanced machine learning techniques, create a diffusion-based image-to-image translation model to produce high-quality relighting of volcap facial performances. The disclosed systems and methods first obtain subject-specific datasets of paired flat-lit and one-light-at-a-time (OLAT) images captured under diverse lighting conditions, with diverse angles and expressions. In some examples, the disclosed systems and methods may train a deformable three-dimensional Gaussian splatting (3DGS) model, which reconstructs dynamic facial performances into novel viewpoints with temporal consistency. In this example, the systems and methods described herein can partition lengthy sequences into segments and use sample keyframes to train the 3DGS model on each segment, further applying temporal blending between keyframes for consistency. By using 3D Gaussian splatting, the disclosed systems and methods also enable rendering novel-view flat-lit images from any position or angle based on the subject-specific training data, potentially creating novel expressions.

The disclosed systems and methods then train a diffusion-based relighting model for video diffusion to relight the sequence of flat-lit image. For example, the systems and methods described herein can train a convolutional neural network with pyramid noise to iteratively remove noise to generate a clean image. In this example, the systems and methods described herein can condition the convolutional neural network with lighting information, such as lighting direction and lighting size, to generate images of a given preferred lighting. In addition, the diffusion-based relighting model can then spatially condition the flat-lit input images, utilizing lighting information as global controls to generate high-quality relit results. Furthermore, a unified lighting control combines a new area lighting representation with directional lighting, offering versatile lighting controls as well as enabling composition of complex environment lighting. By using the scalable dynamic Gaussian splatting technique to reconstruct long sequences, the systems and methods described herein can also ensure temporal consistency in flat-lit inputs for coherent inference by the relighting model.

The systems and methods described herein may improve the functioning of a computing device by reducing hardware requirements and increasing robustness of dynamic digital video relighting. The systems and methods described herein can then enable efficient hardware utilization and scalability for large datasets, supporting real-time or near-real-time applications such as relighting virtual and augmented reality avatars. For example, by optimizing for given hardware and maintaining Gaussian splatting renders to process on one device, the disclosed systems and methods improve the speed of rendering and reduce bus traffic. By reducing the number of inferences in relighting images, the disclosed systems and methods also increase the efficiency of processing images and videos. In addition, these systems and methods may improve the fields of image processing and digital content creation by maintaining quality and consistency in relit images and videos. For example, diffusion models can generate high-quality images by sampling from a learned distribution of natural images, particularly when conditioned on spatial control via image-to-image translation, thereby improving photorealism. As another example, by focusing on reconstructing videos to maintain fidelity to a specific subject, the systems and methods described herein improve precise lighting control that is generalizable across various facial expressions, preserving detailed features such as skin texture, reflectance, and hair structure while maintaining subject-specific identity features. Thus, the disclosed systems and methods may improve over traditional methods of relighting images by training a personalized model capable of relighting flat-lit images of a subject with novel views, novel lightings, and novel expressions.

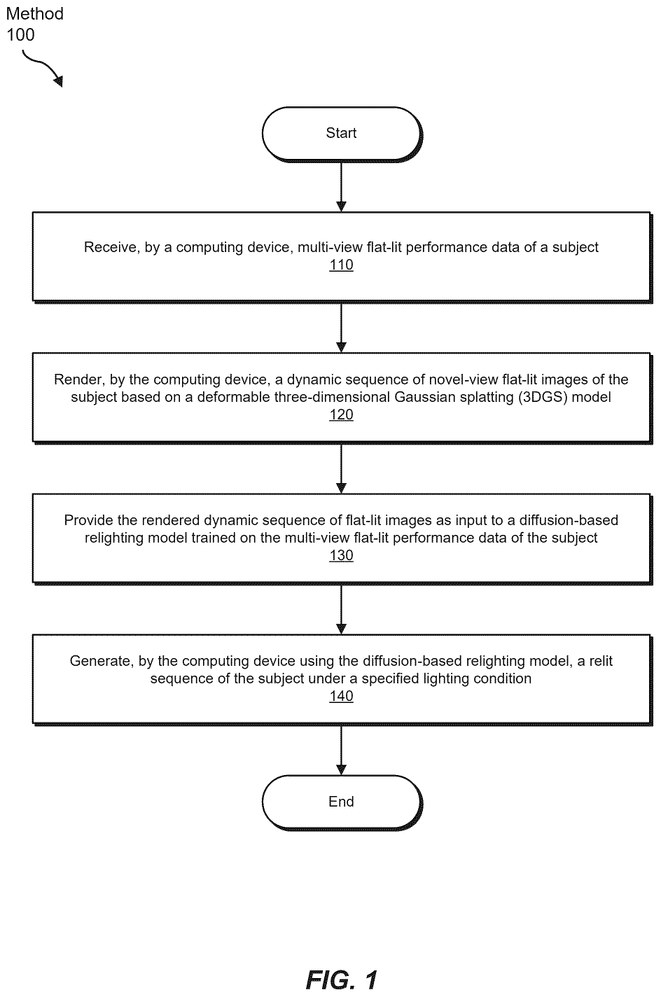

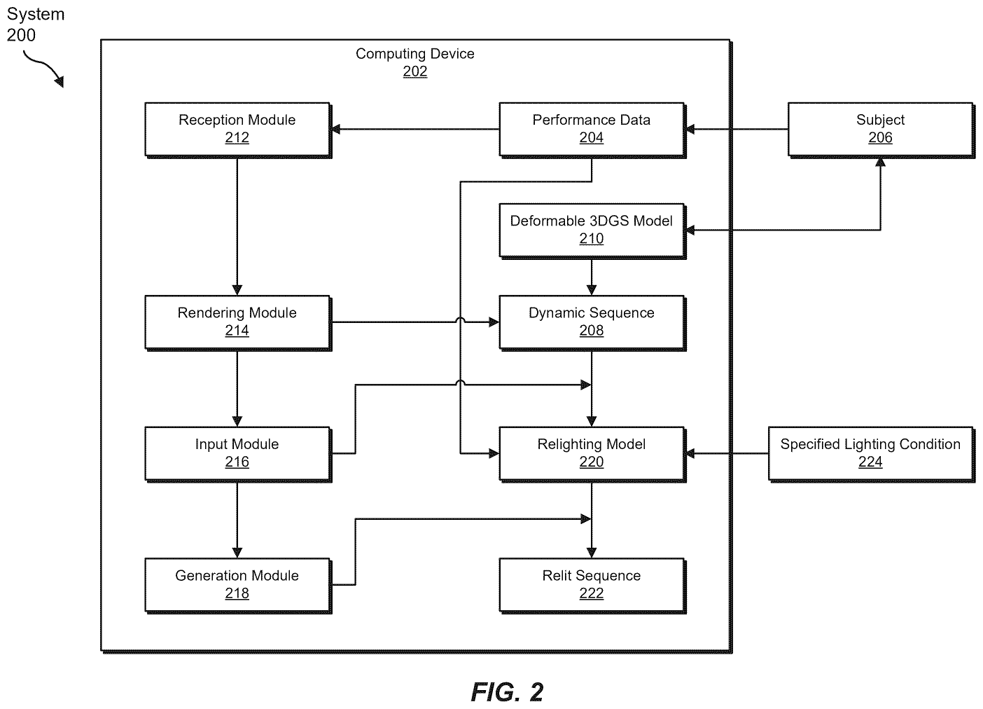

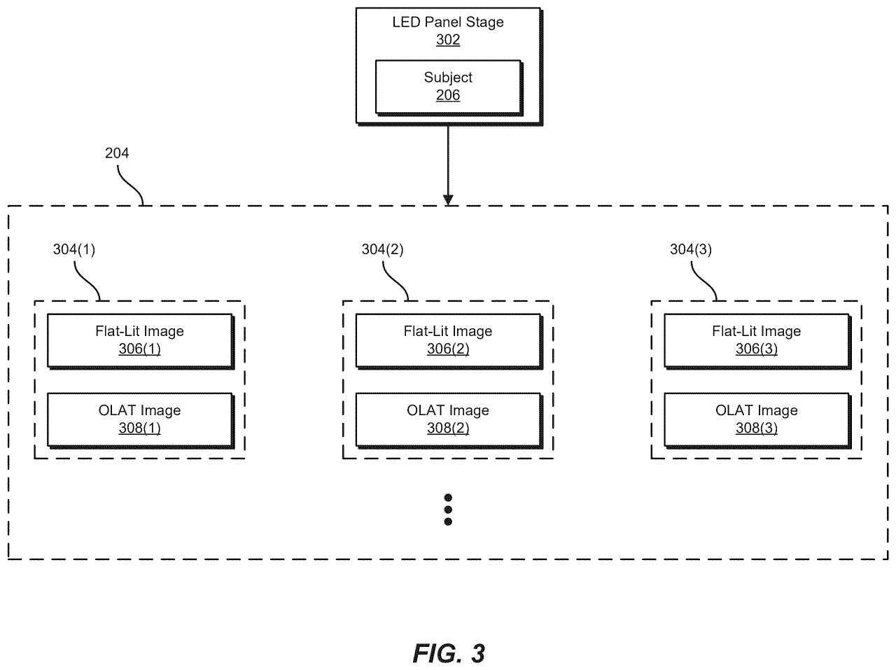

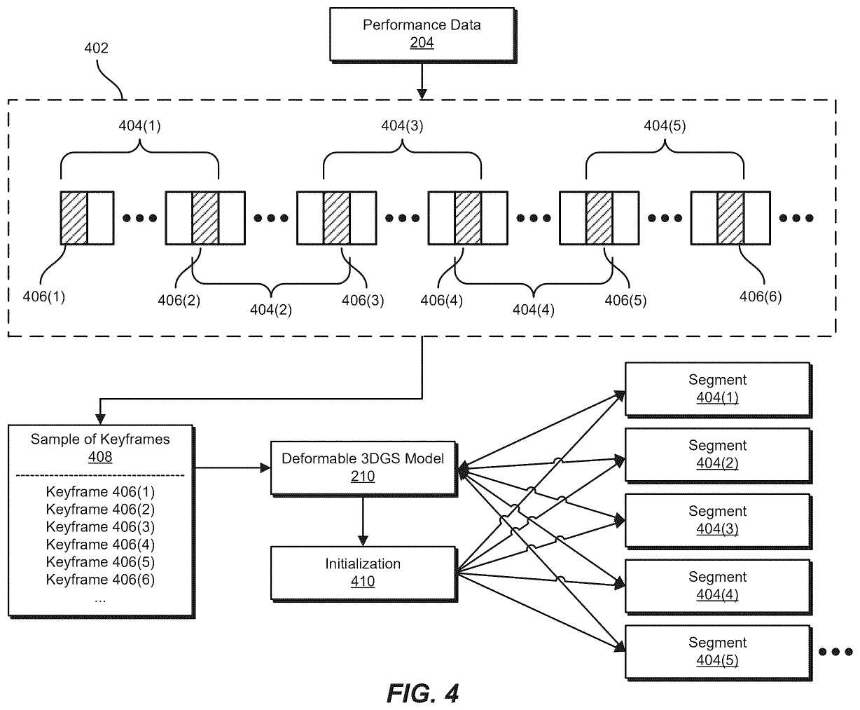

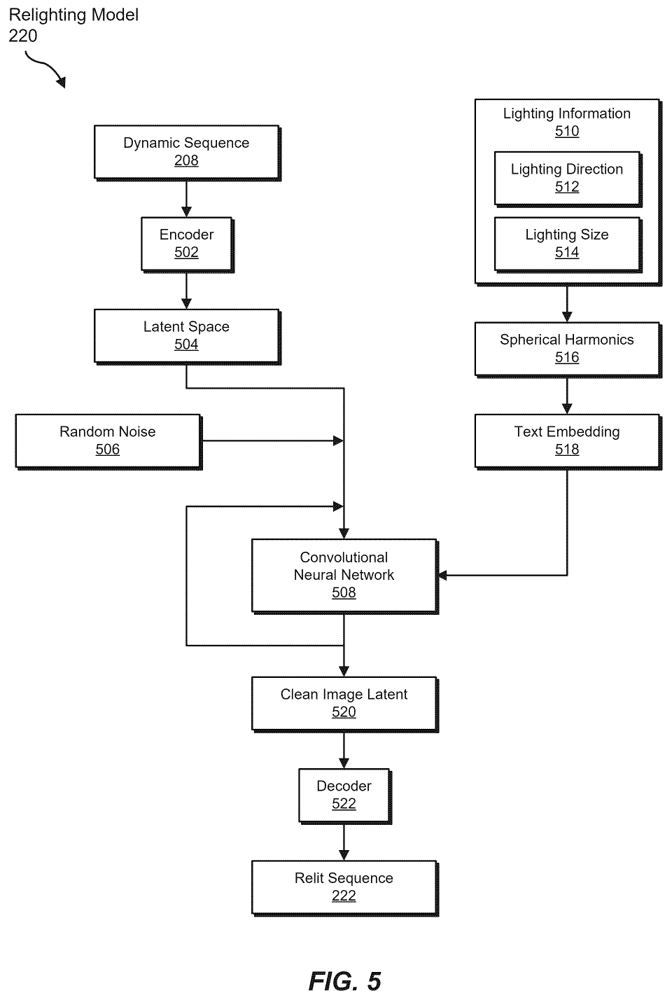

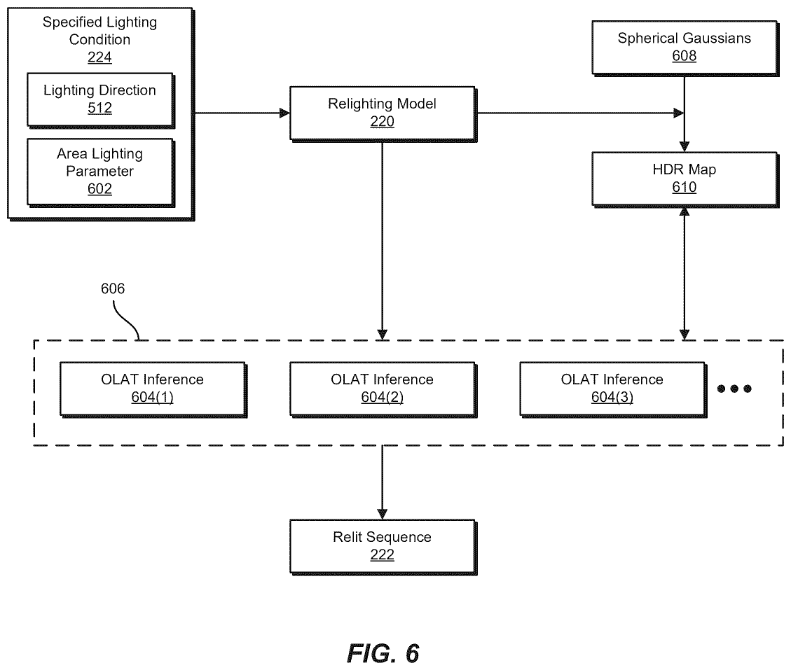

Thereafter, the description will provide, with reference to FIG. 1, detailed descriptions of computer-implemented methods for diffusion-based facial performance relighting. Detailed descriptions of a corresponding exemplary computing system will be provided in connection with FIG. 2. Detailed descriptions of an exemplary image capture process will be provided in connection with FIG. 3. In addition, detailed descriptions of an exemplary deformable 3DGS model will be provided in connection with FIG. 4. Detailed descriptions of an exemplary diffusion-based relighting model will be provided in connection with FIG. 5. Furthermore, detailed descriptions of an exemplary environmental relighting will be provided in connection with FIG. 6.

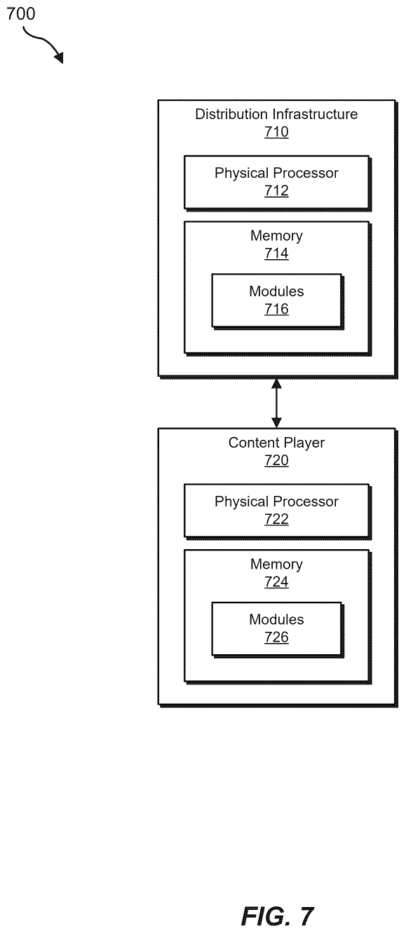

Because many of the embodiments described herein may be used with substantially any type of computing network, including distributed networks designed to provide video content to a worldwide audience, various computer network and video distribution systems will initially be described with reference to FIGS. 7-9. These figures will introduce the various networks and distribution methods used to provision video content to users.

FIG. 1 is a flow diagram of an exemplary computer-implemented method 100 for page hydration. The steps shown in FIG. 1 may be performed by any suitable computer-executable code and/or computing system, including the systems illustrated in FIGS. 7-9, computing device 202 in FIG. 2, or a combination of one or more of the same. In one example, each of the steps shown in FIG. 1 may represent an algorithm whose structure includes and/or is represented by multiple sub-steps, examples of which will be provided in greater detail below. In some examples, all of the steps and sub-steps represented in FIG. 1 may be performed by one device (e.g., either a server or a client computing device). Alternatively, the steps and/or substeps represented in FIG. 1 may be performed across multiples devices (e.g., some of steps and/or sub-steps may be performed by a server and other steps and/or sub-steps may be performed by a client computing device).

As illustrated in FIG. 1, at step 110, one or more of the systems described herein may receive, by a computing device, multi-view flat-lit performance data of a subject. For example, FIG. 2 is a block diagram of an exemplary system 200 for diffusion-based facial performance relighting. As illustrated in FIG. 2, a reception module 212 may, as part of a computing device 202, receives multi-view flat-lit performance data 204 of a subject 206.

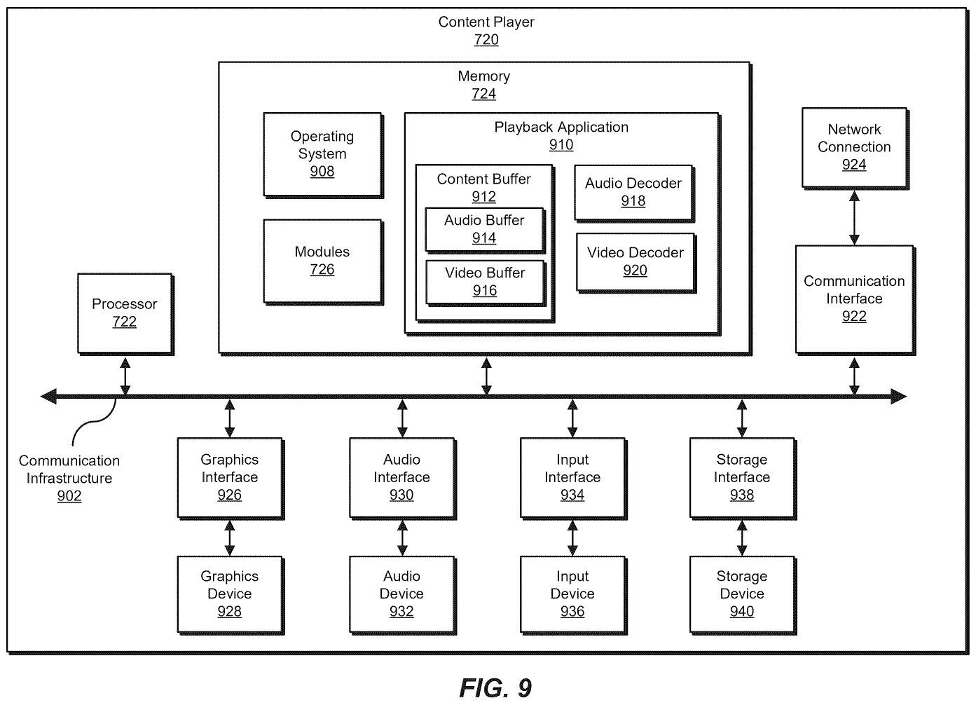

In some embodiments, computing device 202 may generally represent any type or form of computing device capable of running computing software and applications to perform diffusion-based facial performance relighting. As used herein, the term “application” generally refers to a software program designed to perform specific functions or tasks and capable of being installed, deployed, executed, and/or otherwise implemented on a computing system. Examples of applications may include, without limitation, playback application 910 of FIG. 9, productivity software, enterprise software, entertainment software, security applications, cloud-based applications, web applications, mobile applications, content access software, simulation software, integrated software, application packages, application suites, variations or combinations of one or more of the same, and/or any other suitable software application. Examples of client devices may include, without limitation, laptops, tablets, desktops, servers, cellular phones, Personal Digital Assistants (PDAs), multimedia players, embedded systems, wearable devices (e.g., smart watches, smart glasses, etc.), gaming consoles, combinations of one or more of the same, or any other suitable computing device. Additionally, client devices may include content player 720 in FIGS. 7 and 9 and/or various other components of FIGS. 7-9.

In other embodiments, computing device 202 may generally represent a server capable of processing user and/or client device requests to perform diffusion-based facial performance relighting. Computing device 202 may alternatively generally represent any type or form of server that is capable of storing and/or managing content and user data, such as videos for a video hosting platform. Examples of a server include, without limitation, security servers, application servers, web servers, storage servers, streaming servers, and/or database servers configured to run certain software applications and/or to provide various security, web, storage, streaming, and/or database services. Additionally, computing device 202 may include distribution infrastructure 710 and/or various other components of FIGS. 7-9.

Although illustrated as part of computing device 202 in FIG. 2, some or all of the modules described herein may alternatively be executed by a separate server or any other suitable computing device. For example, computing device 202 may represent a front-end device for diffusion-based facial performance relighting or, alternatively, may represent part of system 200 for backend diffusion-based facial performance relighting. As another example, computing device 202 may represent an endpoint device or multiple endpoint devices that service client devices. For example, system 200 may include multiple servers and/or computing devices that include computing device 202, databases hosting a variety of data and backend services, and/or any other suitable device or combination of devices.

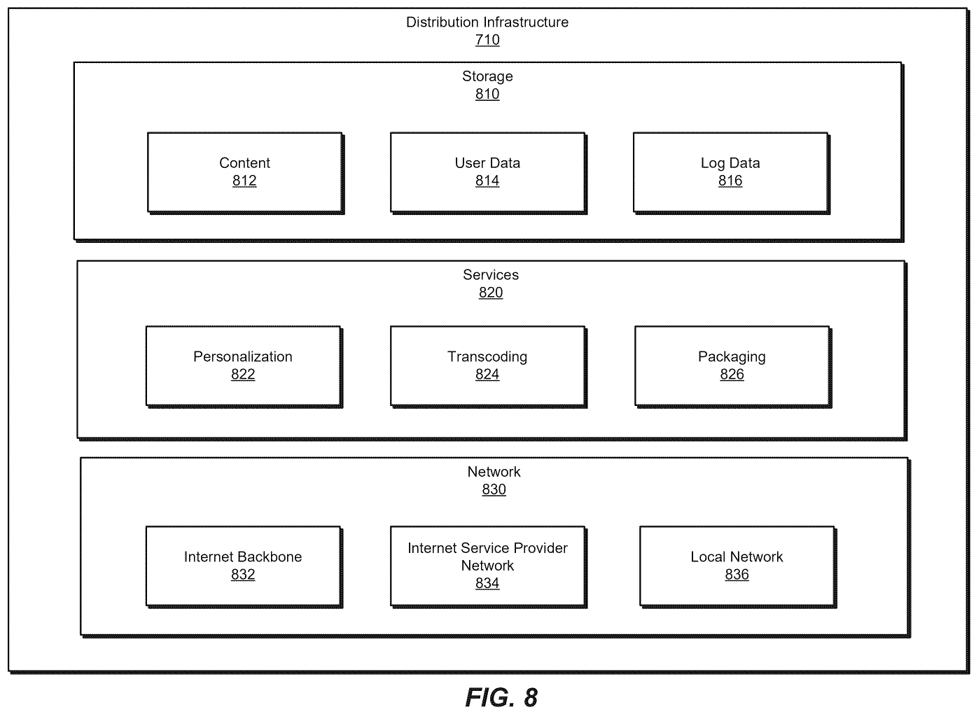

In the above embodiments, computing device 202 may be directly in communication with other servers and/or in communication with other computing devices via a network. In some examples, the term “network” may refer to any medium or architecture capable of facilitating communication or data transfer. Examples of networks include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), network 830 of FIG. 8, or any other suitable network. For example, a network may facilitate data transfer between computing device 202 and other devices using wireless or wired connections.

The systems described herein may perform step 110 in a variety of ways. In some embodiments, subject 206 may represent an individual, such as a human subject, capable of being capture through photography. In other embodiments, subject 206 may represent any object or living being that may be digitally captured. In one example, the term “flat-lit rendering” may refer to a method of generating an image with a goal of minimal shading and shadows.

In one embodiment, multi-view flat-lit performance data 204 includes pairs of images for subject 206, wherein each pair of images includes a flat-lit image and a one-light-at-a-time (OLAT) image that is identical to the flat-lit image except for lighting. In some examples, OLAT rendering may refer to a method of generating an image from a scene that is captured with a single light source illuminated at a given time. In the above embodiment, the pairs of images include images with a range of subject positions, angles, and lighting conditions. Additionally, the pairs of images may be captured by a light emitting diode (LED) panel stage. For example, the LED panel stage may be part of a volumetric performance capture (volcap) system can capture a three-dimensional space through an enclosed cylinder of LED panels with a multi-view camera array arranged in between panel gaps. In this example, the volcap system may then transmit performance data 204 to computing device 202.

As shown in FIG. 3, an LED panel stage 302 captures at least pairs 304 (1)-(3) of flat-lit images 306 (1)-(3) and OLAT images 308 (1)-(3). In this example, LED panel stage 302 may capture flat-lit images 306 (1)-(3) from a variety of directions and camera angles for a multitude of expressions or subject positions. By turning on different LED panels, LED panel stage 302 may also capture subject 206 under a dense array of different lighting directions, with each of OLAT images 308 (1)-(3) lit by a single light source. In this example, each of pairs 304 (1)-(3) include identical images wherein lighting is the only changing variable. Additionally, LED panel stage 302 may capture images as part of video capture, with multiple frames for each video sequence. Further, LED panel stage 302 may capture a sequence without subject 206, with flat-lit and/or OLAT images, for background removal during 3DGS reconstruction. In some embodiments, the disclosed systems and methods may also conduct optical flow alignment in image space with respect to the flat-lit frames for each view to compensate for inadvertent movement by subject 206 during OLAT image capture. In additional embodiments, flat-lit images 306 (1)-(3) and OLAT images 308 (1)-(3) can be converted to sRGB space for compatibility with pretrained model weights. In some examples, the term “sRGB” generally refers to a specific standardized color space based on the red, green, and blue (RGB) color model.

Returning to FIG. 1, at step 120, one or more of the systems described herein may render, by the computing device, a dynamic sequence of novel-view flat-lit images of the subject based on a deformable three-dimensional Gaussian splatting (3DGS) model. For example, a rendering module 214 may, as part of computing device 202 in FIG. 2, render a dynamic sequence 208 of novel-view flat-lit images of subject 206 based on a deformable 3DGS model 210.

The systems described herein may perform step 120 in a variety of ways. In some examples, the term “Gaussian” generally refers to a mathematical function that describes a distribution of values. In particular, a Gaussian function, as used in graphics, refers to a function that smoothly spreads out from its center, creating a soft, blurry effect. In some examples, the term “Gaussian splatting” generally refers to rendering technique that represents a 3D scene as a collection of overlapping Gaussians, which are then projected onto an image to create details.

In some embodiments, deformable 3DGS model 210 is trained by partitioning a training sequence in performance data 204 into segments, training deformable 3DGS model 210 on a sample of keyframes as an initialization, and training deformable 3DGS model 210 for each segment conditioned on the initialization. In these embodiments, each segment contains a beginning keyframe and an end keyframe from the sample of keyframes, wherein training deformable 3DGS model 210 for each segment is based on a timestamp of the beginning keyframe. In these embodiments, a sequence may represent a video as a collection of frames, with selected frames used as keyframes. For example, the training sequence may be divided into segments of equal numbers of frames, with each keyframe representing the end of one segment and the beginning of the next segment and allowing varying Gaussians across segments.

As shown in FIG. 4, performance data 204 may be converted into a training sequence 402 that contains a number of frames. In this example, keyframes 406 (1)-(6) represent the beginning and ending frames of segments 404 (1)-(5). For example, keyframe 406 (2) is the last frame of segment 404 (1) and the first frame of segment 404 (2). In this example, a sample of keyframes 408 is used to train deformable 3DGS model 210 as an initialization 410. In this example, a separate step is performed to train deformable 3DGS model 210 for each of segments 404 (1)-(5), conditioned on initialization 410.

In some examples, rendering module 214 renders dynamic sequence 208 of flat-lit images by reconstructing deformed Gaussians based on deformable 3DGS model 210. As used herein, the term “deformed Gaussian” generally refers to a Gaussian function that is flexibly changed or deformed to better fit details of a 3D scene. In other words, deformable 3DGS model 210 is applied to dynamic sequence 208 of dynamic facial performances in a consistent, flat-lit environment, and dynamic sequence 208 is then reconstructed for novel-view synthesis using scalable deformable 3DGS model 210. In this example, deformable 3DGS model 210 extrapolates the facial performance to novel viewpoints by constructing deformable Gaussians.

In some embodiments, the deformable Gaussians may be optimized for longer sequences to ensure temporal consistency during reconstruction. Rather than using globally shared Gaussians for an entire sequence, the disclosed systems and methods enable the use of varying Gaussians for different segments, using the two-step process of training to maintain temporal consistency between segments. In these embodiments, deformable 3DGS model 210 ensures the initial states of 3D Gaussians in different segments are temporally consistent with similar levels of details. Additionally, a deformation network can be trained to improve consistency for warm-up iterations in initialization 410, with warm-up training enabling Gaussians to free deform to reconstruct movement while being restricted to the deformation of keyframes at transition points. At the second step, deformation 3DGS model 210 can relax constraints to enable Gaussians to clone, split, and prune for detailed reconstruction for a number of iterations. Thus, Gaussians can be deformed and interpolated to reduce the accumulation of errors between segments.

Returning to FIG. 1, at step 130, one or more of the systems described herein may provide the rendered dynamic sequence of flat-lit images as input to a diffusion-based relighting model trained on the multi-view flat-lit performance data of the subject. For example, an input module 216 may, as part of computing device 202 in FIG. 2, provide rendered dynamic sequence 208 of flat-lit images as input to a diffusion-based relighting model 220 trained on performance data 204 of subject 206.

The systems described herein may perform step 130 in a variety of ways. In one embodiment, performance data 204 can be used to supervise training of relighting model 220 to infer from flat lighting to arbitrary lighting. In this embodiment, relighting model 220 may represent a model fine tuned and personalized for subject 206 using performance data 204. In other words, relighting model 220 may be trained to specifically perform relighting for subject 206 from dynamic sequence 208 of flat-lit images to an arbitrary combination of lighting conditions, angles, and subject positions. In other embodiments, relighting model 220 may leverage one or more existing models, such as by fine-tuning a pretrained latent diffusion model with paired data of performance data 204 conditioned on lighting information. In some examples, input module 216 provides dynamic sequence 208 as input to relighting model 220 by sending each frame of dynamic sequence 208 as an image to perform image-to-image translation.

Returning to FIG. 1, at step 140, one or more of the systems described herein may generate, by the computing device using the diffusion-based relighting model, a relit sequence of the subject under a specified lighting condition. For example, a generation module 218 may, as part of computing device 202 in FIG. 2, generate a relit sequence 222 of subject 206 under a specified lighting condition 224 using relighting model 220.

The systems described herein may perform step 140 in a variety of ways. In some examples, generation module 218 uses relighting model 220 to generate relit sequence 222 by encoding dynamic sequence 208 into latent space, concatenating encoded dynamic sequence 208 with random noise for input to a convolutional neural network, conditioning the input to the convolutional neural network with text embedding containing lighting information, and decoding a result of the convolutional neural network as relit sequence 222. As used herein, the term “encoding” generally refers to a process of converting data from one format to another format, such as an image format into a text representation. Similarly, the term “decoding” generally refers to a process of converting data from an encoded format back to an original format, such as the text representation back to the image format. The term “latent space,” as used herein, generally refers to a mathematical space of unobserved or hidden variables within a model where complex data is represented in an abstract form. The term “neural network,” as used herein, generally refers to a model of connected data that is weighted based on input data and used to estimate a function. For example, a convolutional neural network may use convolution and other machine learning techniques to modify a sequence in order to condense the size and complexity of the data and detect features within the data. As used herein, the term “machine learning” generally refers to a computational algorithm that may learn from data in order to make predictions. As used herein, the term “embedding” generally refers to a representation of data mapped to a vector space, such as images represented in text format.

In some embodiments, the lighting information is encoded using spherical harmonics, wherein spherical Gaussians determine lighting direction and lighting size. As used herein, the term “spherical harmonics” generally refers to functions defined over the surface of a sphere to describe patterns on the sphere as weighted sums. As used herein, the term “spherical Gaussians” generally refers to Gaussians used to model light distribution over an area. In these embodiments, spherical harmonics encode single light directions into a higher dimensional space, increasing the precision and the frequency of conditioning. The spherical harmonics encoding may also be padded to match the length of the text embedding.

In some examples, the convolutional neural network is trained to predict noise for the latent space of dynamic sequence 208 such that relighting model 220 iteratively removes the noise from the random noise to generate a clean image latent, wherein the convolutional neural network is trained using pyramid noise. As used herein, the term “pyramid noise” generally refers to a type of multi-resolution noise at different spatial scales that is added during diffusion model training to process details at different levels of coarseness. By training relighting model 220 with pyramid noise, the disclosed systems and methods can improve color fidelity and enable more accurate predictions of darker pixels in images with less color shifting. The disclosed systems and methods can also improve modeling of different frequency bands of images by initially using pyramid noise for depths and molecular depths estimation. Additionally, the convolutional neural network may be conditioned with a video diffusion model.

As shown in FIG. 5, dynamic sequence 208 is encoded by an encoder 502, which may represent a variational autoencoder, into a latent space 504. In this example, random noise 506 may be concatenated with the encoded data as input to a convolutional neural network 508. Additionally, lighting information 510, which conditions performance data 204, may include data on lighting direction 512 and lighting size 514. In this example, spherical harmonics 516 may be applied to encode lighting information 510 as a text embedding 518. Subsequently, text embedding 518 may condition the input to convolutional neural network 508 before outputting a clean image latent 520. In this example, multiple iterations of denoising may be performed by convolutional neural network 508 before producing a sufficiently clean image latent. In this example, a decoder 522, which may be the variational autoencoder, then decodes clean image latent 520 to generate relit sequence 222.

In the above examples, relighting model 220 generates new lighting for rendered dynamic sequence 208 based on specified lighting condition 224, which provides specific details for lighting information 510. In these examples, convolutional neural network 508 predicts noise of partially denoised latents that are conditioned on text embeddings and diffusion timestamps. In these examples, convolutional neural network 508 iteratively removes noise from random noise 506 to transform dynamic sequence 208 in latent space 504 into clean image latent 520. By concatenating flat-lit images with a random noise map, generation module 218 may retain pretrained weights and improve alignment of the spatial structure between relit sequence 222 and dynamic sequence 208. In other words, flat-lit images of dynamic sequence 208 provide spatial cues for relit sequence 222 while lighting information 510 acts as a global control signal to influence the relit images as a whole.

In some embodiments, specified lighting condition 224 includes one or more of a lighting direction and/or an area lighting parameter. For example, specified lighting condition 224 may include lighting information 510. In some embodiments, generation module 218 generates relit sequence 222 by adjusting specified lighting condition 224 to reconstruct a high dynamic range (HDR) map by compositing a set of OLAT inferences using spherical Gaussians. As used herein, the term “high dynamic range” generally refers to a method to capture or represent images with a wide range of brightness and color levels, particularly for high contrast details. In these embodiments, relighting model 220 uses a unified lighting control by integrating novel area lighting representations with directional lighting, enabling joint adjustments in light size and direction. In these embodiments, the unified lighting control may control area light and HDR environment light. For example, relighting model 220 is trained on examples of lighting information 510 with different lighting directions and sizes to infer area lighting. Similarly, relighting model 220 is trained on multiple directional lights and spherical Gaussians to produce HDR reconstruction of environmental lighting.

As shown in FIG. 6, specified lighting condition 224 may include lighting direction 512 and an area lighting parameter 602, which may include a lighting size and/or sharpness. In this example, generation module 218 composites a set of OLAT inferences 606 using spherical Gaussians 608 to reconstruct an HDR map 610. In this example, relighting model 220 composites OLAT inferences 604 (1)-(3) of different directional lighting to map to HDR map 610 and adjust relit sequence 222 based on the mapping.

In some examples, the above described methods may further include applying temporal blending to relit sequence 222 by interpolating relit results between keyframes. In these examples, temporal blending may sample keyframes and preserve details and lighting accuracy between segments of longer sequences. In these examples, the partitioning process of deformable 3DGS model 210 may be applied to ensure consistency and blending between segments by interpolating relit images of keyframes. In other words, the disclosed systems and methods may perform post-processing with a video diffusion model to ensure temporal consistency for the duration of a video or relit sequence 222.

Although described as trained on subject-specific data, relighting model 220 may be used for novel subjects after training on multiple subjects. Additionally, deformable 3DGS model 210 and/or relighting model 220 may be optimized to minimize copy between devices or components of a single device to reduce bus traffic and latency.

As explained above in connection with method 100 in FIG. 1, the disclosed systems and methods, by leveraging a diffusion-based relighting model, can accurately reproduce complex lighting effects for novel lighting conditions, viewpoints, and facial expressions. Specifically, the disclosed systems and methods first capture pairs of flat-lit and OLAT images to train the model. For example, the disclosed systems and methods can use a LED panel stage to capture different lighting effects and positions of a particular subject. By training the model using subject-specific data, the systems and methods described herein can more accurately predict images for a preferred lighting condition. Additionally, the system and methods described herein train a 3DGS model to generate flat-lit image sequences with novel views of the subject. The disclosed systems and methods may also use 3D Gaussians as a geometry representation for capturing fine details in real-time rendering.

The disclosed systems and methods then relight dynamically generated sequences with the relighting model, applying unified lighting controls to the relit sequences. For example, the systems and methods described herein can relight a sequence of flat-lit images with a specified directional lighting or environmental lighting. In addition, the disclosed systems and methods use spherical harmonics to encode lighting conditions and improve complex effects, such as reflections, subsurface scattering, self-shadowing, and translucency. Furthermore, by applying temporal blending for segments of a longer sequence, the disclosed systems and methods can ensure temporal consistency and reduce errors or flickering. Thus, the systems and methods described herein may improve over traditional methods of dynamically relighting videos for better lighting accuracy, color fidelity, and overall image quality.

Content that is created or modified using the methods described herein may be used and/or distributed in a variety of ways and/or by a variety of systems. Such systems may include content distribution ecosystems, as shown in FIGS. 7-9.

FIG. 7 is a block diagram of a content distribution ecosystem 700 that includes a distribution infrastructure 710 in communication with a content player 720. In some embodiments, distribution infrastructure 710 may be configured to encode data and to transfer the encoded data to content player 720 via data packets. Content player 720 may be configured to receive the encoded data via distribution infrastructure 710 and to decode the data for playback to a user. The data provided by distribution infrastructure 710 may include audio, video, text, images, animations, interactive content, haptic data, virtual or augmented reality data, location data, gaming data, or any other type of data that may be provided via streaming.

Distribution infrastructure 710 generally represents any services, hardware, software, or other infrastructure components configured to deliver content to end users. For example, distribution infrastructure 710 may include content aggregation systems, media transcoding and packaging services, network components (e.g., network adapters), and/or a variety of other types of hardware and software. Distribution infrastructure 710 may be implemented as a highly complex distribution system, a single media server or device, or anything in between. In some examples, regardless of size or complexity, distribution infrastructure 710 may include at least one physical processor 712 and at least one memory device 714. One or more modules 716 may be stored or loaded into memory 714 to enable adaptive streaming, as discussed herein.

Content player 720 generally represents any type or form of device or system capable of playing audio and/or video content that has been provided over distribution infrastructure 710. Examples of content player 720 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 710, content player 720 may include a physical processor 722, memory 724, and one or more modules 726. Some or all of the adaptive streaming processes described herein may be performed or enabled by modules 726, and in some examples, modules 716 of distribution infrastructure 710 may coordinate with modules 726 of content player 720 to provide adaptive streaming of multimedia content.

In certain embodiments, one or more of modules 716 and/or 726 in FIG. 7 may represent one or more software applications or programs that, when executed by a computing device, may cause the computing device to perform one or more tasks. For example, and as will be described in greater detail below, one or more of modules 716 and 726 may represent modules stored and configured to run on one or more general-purpose computing devices. One or more of modules 716 and 726 in FIG. 7 may also represent all or portions of one or more special-purpose computers configured to perform one or more tasks.

Physical processors 712 and 722 generally represent any type or form of hardware-implemented processing unit capable of interpreting and/or executing computer-readable instructions. In one example, physical processors 712 and 722 may access and/or modify one or more of modules 716 and 726, respectively. Additionally or alternatively, physical processors 712 and 722 may execute one or more of modules 716 and 726 to facilitate adaptive streaming of multimedia content. Examples of physical processors 712 and 722 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 714 and 724 generally represent any type or form of volatile or non-volatile storage device or medium capable of storing data and/or computer-readable instructions. In one example, memory 714 and/or 724 may store, load, and/or maintain one or more of modules 716 and 726. Examples of memory 714 and/or 724 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 8 is a block diagram of exemplary components of content distribution infrastructure 710 according to certain embodiments. Distribution infrastructure 710 may include storage 810, services 820, and a network 830. Storage 810 generally represents any device, set of devices, and/or systems capable of storing content for delivery to end users. Storage 810 may include a central repository with devices capable of storing terabytes or petabytes of data and/or may include distributed storage systems (e.g., appliances that mirror or cache content at Internet interconnect locations to provide faster access to the mirrored content within certain regions). Storage 810 may also be configured in any other suitable manner.

As shown, storage 810 may store, among other items, content 812, user data 814, and/or log data 816. Content 812 may include television shows, movies, video games, user-generated content, and/or any other suitable type or form of content. User data 814 may include personally identifiable information (PII), payment information, preference settings, language and accessibility settings, and/or any other information associated with a particular user or content player. Log data 816 may include viewing history information, network throughput information, and/or any other metrics associated with a user's connection to or interactions with distribution infrastructure 710.

Services 820 may include personalization services 822, transcoding services 824, and/or packaging services 826. Personalization services 822 may personalize recommendations, content streams, and/or other aspects of a user's experience with distribution infrastructure 710. Encoding services, such as transcoding services 824, may compress media at different bitrates which may enable real-time switching between different encodings. Packaging services 826 may package encoded video before deploying it to a delivery network, such as network 830, for streaming.

Network 830 generally represents any medium or architecture capable of facilitating communication or data transfer. Network 830 may facilitate communication or data transfer via transport protocols using wireless and/or wired connections. Examples of network 830 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 8, network 830 may include an Internet backbone 832, an internet service provider 834, and/or a local network 836.

FIG. 9 is a block diagram of an exemplary implementation of content player 720 of FIG. 7. Content player 720 generally represents any type or form of computing device capable of reading computer-executable instructions. Content player 720 may include, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 9, in addition to processor 722 and memory 724, content player 720 may include a communication infrastructure 902 and a communication interface 922 coupled to a network connection 924. Content player 720 may also include a graphics interface 926 coupled to a graphics device 928, an audio interface 930 coupled to an audio device 932, an input interface 934 coupled to an input device 936, and a storage interface 938 coupled to a storage device 940.

Communication infrastructure 902 generally represents any type or form of infrastructure capable of facilitating communication between one or more components of a computing device. Examples of communication infrastructure 902 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 724 generally represents any type or form of volatile or non-volatile storage device or medium capable of storing data and/or other computer-readable instructions. In some examples, memory 724 may store and/or load an operating system 908 for execution by processor 722. In one example, operating system 908 may include and/or represent software that manages computer hardware and software resources and/or provides common services to computer programs and/or applications on content player 720.

Operating system 908 may perform various system management functions, such as managing hardware components (e.g., graphics interface 926, audio interface 930, input interface 934, and/or storage interface 938). Operating system 908 may also process memory management models for playback application 910. The modules of playback application 910 may include, for example, a content buffer 912, an audio decoder 918, and a video decoder 920.

Playback application 910 may be configured to retrieve digital content via communication interface 922 and play the digital content through graphics interface 926. A video decoder 920 may read units of video data from audio buffer 914 and/or video buffer 916 and may output the units of video data in a sequence of video frames corresponding in duration to the fixed span of playback time. Reading a unit of video data from video buffer 916 may effectively de-queue the unit of video data from video buffer 916. The sequence of video frames may then be rendered by graphics interface 926 and transmitted to graphics device 928 to be displayed to a user.

In situations where the bandwidth of distribution infrastructure 710 is limited and/or variable, playback application 910 may download and buffer consecutive portions of video data and/or audio data from video encodings with different bit rates based on a variety of factors (e.g., scene complexity, audio complexity, network bandwidth, device capabilities, etc.). In some embodiments, video playback quality may be prioritized over audio playback quality. Audio playback and video playback quality may also be balanced with each other, and in some embodiments audio playback quality may be prioritized over video playback quality.

Content player 720 may also include a storage device 940 coupled to communication infrastructure 902 via a storage interface 938. Storage device 940 generally represent any type or form of storage device or medium capable of storing data and/or other computer-readable instructions. For example, storage device 940 may be a magnetic disk drive, a solid-state drive, an optical disk drive, a flash drive, or the like. Storage interface 938 generally represents any type or form of interface or device for transferring data between storage device 940 and other components of content player 720.

Many other devices or subsystems may be included in or connected to content player 720. Conversely, one or more of the components and devices illustrated in FIG. 9 need not be present to practice the embodiments described and/or illustrated herein. The devices and subsystems referenced above may also be interconnected in different ways from that shown in FIG. 9. Content player 720 may also employ any number of software, firmware, and/or hardware configurations.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive an image sequence to be transformed, transform the image sequence to create novel flat-lit images, output a result of the transformation to a diffusion-based relighting model, use the result of the transformation to relight the image sequence, and store the result of the transformation to create a new video. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, by a computing device, multi-view flat-lit performance data of a subject;
rendering, by the computing device, a dynamic sequence of novel-view flat-lit images of the subject based on a deformable three-dimensional Gaussian splatting (3DGS) model;
providing the rendered dynamic sequence of flat-lit images as input to a diffusion-based relighting model trained on the multi-view flat-lit performance data of the subject; and
generating, by the computing device using the diffusion-based relighting model, a relit sequence of the subject under a specified lighting condition.

2. The method of claim 1, wherein the multi-view flat-lit performance data comprises pairs of images for the subject, wherein each pair of images comprises:
a flat-lit image; and
a one-light-at-a-time (OLAT) image that is identical to the flat-lit image except for lighting.

3. The method of claim 2, wherein the pairs of images comprise images with a range of:
subject positions;
angles; and
lighting conditions.

4. The method of claim 2, wherein the pairs of images are captured by a light emitting diode (LED) panel stage.

5. The method of claim 1, wherein the deformable 3DGS model is trained by:
partitioning a training sequence in the multi-view flat-lit performance data into segments;
training the deformable 3DGS model on a sample of keyframes as an initialization; and
training the deformable 3DGS model for each segment conditioned on the initialization.

6. The method of claim 5, wherein each segment contains a beginning keyframe and an end keyframe from the sample of keyframes, wherein training the deformable 3DGS model for each segment is based on a timestamp of the beginning keyframe.

7. The method of claim 1, wherein rendering the dynamic sequence of flat-lit images comprises reconstructing deformed Gaussians based on the deformable 3DGS model.

8. The method of claim 1, wherein the diffusion-based relighting model generates the relit sequence by:
encoding the dynamic sequence of flat-lit images into latent space;
concatenating the encoded dynamic sequence of flat-lit images with random noise for input to a convolutional neural network;
conditioning the input to the convolutional neural network with text embedding containing lighting information; and
decoding a result of the convolutional neural network as the relit sequence.

9. The method of claim 8, wherein the lighting information is encoded using spherical harmonics, wherein spherical Gaussians determine lighting direction and lighting size.

10. The method of claim 8, wherein the convolutional neural network is trained to predict noise for the latent space of the dynamic sequence of flat-lit images such that the diffusion-based relighting model iteratively removes the noise from the random noise to generate a clean image latent, wherein the convolutional neural network is trained using pyramid noise.

11. The method of claim 1, wherein the specified lighting condition comprises at least one of:
a lighting direction; or
an area lighting parameter.

12. The method of claim 1, wherein generating the relit sequence comprises adjusting the specified lighting condition to reconstruct a high dynamic range map by compositing a set of OLAT inferences using spherical Gaussians.

13. The method of claim 1, further comprising applying temporal blending to the relit sequence by interpolating relit results between keyframes.

14. A system comprising:
a reception module, stored in memory, that receives, by a computing device, multi-view flat-lit performance data of a subject;
a rendering module, stored in memory, that renders, by the computing device, a dynamic sequence of novel-view flat-lit images of the subject based on a deformable three-dimensional Gaussian splatting (3DGS) model;
an input module, stored in memory, that provides the rendered dynamic sequence of flat-lit images as input to a diffusion-based relighting model trained on the multi-view flat-lit performance data of the subject;
a generation module, stored in memory, that generates, by the computing device using the diffusion-based relighting model, a relit sequence of the subject under a specified lighting condition; and
at least one processor that executes the reception module, the rendering module, the input module, and the generation module.

15. The system of claim 14, wherein the multi-view flat-lit performance data comprises pairs of images for the subject, wherein each pair of images comprises:
a flat-lit image; and
a one-light-at-a-time (OLAT) image that is identical to the flat-lit image except for lighting.

16. The system of claim 14, wherein the deformable 3DGS model is trained by:
partitioning a training sequence in the multi-view flat-lit performance data into segments;
training the deformable 3DGS model on a sample of keyframes as an initialization; and
training the deformable 3DGS model for each segment conditioned on the initialization.

17. The system of claim 14, wherein the generation module uses the diffusion-based relighting model to generate the relit sequence by:
encoding the dynamic sequence of flat-lit images into latent space;
concatenating the encoded dynamic sequence of flat-lit images with random noise for input to a convolutional neural network;
conditioning the input to the convolutional neural network with text embedding containing lighting information; and
decoding a result of the convolutional neural network as the relit sequence.

18. The system of claim 17, wherein the convolutional neural network is trained to predict noise for the latent space of the dynamic sequence of flat-lit images such that the diffusion-based relighting model iteratively removes the noise from the random noise to generate a clean image latent, wherein the convolutional neural network is trained using pyramid noise.

19. The system of claim 14, wherein the generation module generates the relit sequence by adjusting the specified lighting condition to reconstruct a high dynamic range map by compositing a set of OLAT inferences using spherical Gaussians.

20. A non-transitory computer-readable medium comprising one or more computer-executable instructions that, when executed by at least one processor of a computing device, cause the computing device to:
receive, by the computing device, multi-view flat-lit performance data of a subject;
render, by the computing device, a dynamic sequence of novel-view flat-lit images of the subject based on a deformable three-dimensional Gaussian splatting (3DGS) model;
provide the rendered dynamic sequence of flat-lit images as input to a diffusion-based relighting model trained on the multi-view flat-lit performance data of the subject; and
generate, by the computing device using the diffusion-based relighting model, a relit sequence of the subject under a specified lighting condition.
